(19) United States
(12) Patent Application Publication
(10) Pub. No.: US 2012/0067620 A1
(43) Pub. Date: Mar. 22, 2012

(54) CABLE CLIP WITH OPEN AND CLOSE MECHANISM

(76) Inventors: Stephen Duddy, Elanora (AU); Benjamin John Davis, Alderly (AU)

(21) Appl. No.: 13/235,785

(22) Filed: Sep. 19, 2011

Related U.S. Application Data
(60) Provisional application No. 61/385,493, filed on Sep. 22, 2010.

(51) Int. Cl. H01B 7/00; B23P 11/00

(52) U.S. Cl. 174/135; 29/428

(57) ABSTRACT

A device and method for capturing cables that uses the force from the vertical movement of inserting or removing a cable to operate a mechanism for opening and closing the device.

### CROSS-REFERENCE TO RELATED APPLICATIONS

This application claims the benefit of U.S. Provisional Application No. 61/385,493, filed Sep. 22, 2010, entitled “Cable Clip with Open and Close Mechanism,” which is incorporated by reference herein.

### FIELD OF THE INVENTION

The present invention relates to improved ways of managing and organizing cables typically found in domestic and office environments.

### BACKGROUND OF THE INVENTION

The advent of personal computers and associated peripherals along with various consumer electronic and household items has dramatically increased the number of cables used to power, connect, control or otherwise interface with a range of devices.

Growth in the portability of electronics has resulted in cables being used more intermittently in static locations before a device is disconnected and taken remotely. This raises issues of how to store, route and tidy cables when not in use.

One way is to place the cables in a drawer or container. However, this is not always convenient given that the cable may be attached to a secondary device, power source, data point or some other connection in a difficult or hard to reach position. In this case it is preferable to have the cable stored in a way that allows for quick and easy to access without affecting how, or where, it may be plugged in.

### SUMMARY

In one preferred aspect, the present invention is directed to a device for holding cables with a hinge mechanism that uses the vertical force derived from inserting or removing a cable to open or close the device.

In another preferred aspect, the present invention is directed to a base and two opposing, movable, identical housing members that interlock and rotate along a common central hinge, wherein the housing members mount to the base through opposing spring clips that provide sufficient force to keep the housing members secured along the common central hinge while allowing them to pivot between a stable open and stable closed state.

In a further preferred aspect, the housing members have recesses at either end perpendicular to and bisecting the same plane as the common central hinge with the very top of each housing member including an interlocking wave-shaped edge.

When the device is closed, the common central hinge rests below a horizontal plane with the top of each housing member interlocking along a wave edge allowing the openings in housing members to create an enclosed cavity with exits running parallel to the common central hinge. When the device is open, the common central hinge rests above the horizontal plane with the top wave edge of each housing member being spaced apart, allowing access to an internal cavity.

In a preferred aspect, the present invention has a common central hinge with two stable resting states being above or below the horizontal plane, the resting states determined by a combination of travel limits in the common central hinge and interference from the interlocking wave edges in conjunction with the opposing force exerted by the base mounting clips acting through the housing members, such that when the common central hinge is horizontal, a force from the mounting clips exceeds stasis, forcing the hinge to naturally seek a stable resting state above or below the horizontal plane.

In another preferred aspect, movement of the common central hinge from the stable open position through the horizontal plane can be caused by exerting a downward force along the top surface of the bottom half of the internal cavity of either the housing member or directly onto the common central hinge.

In a further preferred aspect, movement of the common central hinge from the stable closed position through the horizontal plane may be caused by exerting a force along the top edge of the recess in either housing member; or along the underside of the wave edge of either housing member. In each circumstance, leveraging such force through the base mounting clips into the lower portion of the housing member causes the common central hinge to move through and above the horizontal plane into the stable, open position.

### BRIEF DESCRIPTION OF THE FIGURES

FIG. 1 is a perspective view of a clip in accordance with one preferred embodiment of the present invention in an open position.

FIG. 2 is an exploded view of the clip of FIG. 1.

FIG. 3 is a side cross sectional view of the clip of FIG. 1 shown in the closed position.

FIG. 4 is a side cross sectional view of the clip of FIG. 1 shown in the open position.

FIG. 5 is a side cross sectional view of the clip of FIG. 1 shown in the open position showing the engagement of a cable with the clip.

FIG. 6 is a perspective view of the clip of FIG. 1 in partial engagement with the cable:

FIG. 7 is a side cross sectional view of the clip of FIG. 1 engaged with the cable in the closed position.

FIG. 8 is a perspective view of the clip of FIG. 1 showing removal of the cable.

FIG. 9 is a perspective view of the clip of FIG. 1 showing movement of the cable axially through the device.

FIG. 10 is a side cross sectional view of a clip in accordance with another preferred embodiment of the present invention in an open position.

FIG. 11 is a side cross sectional view of the clip of FIG. 10 in a closed position.

FIG. 12 is a rear view of an entertainment stand with the clip of FIG. 10 shown in use managing cables to multiple components shown in dotted outline.

FIG. 13 is a side cross sectional view of the base of the clip of FIG. 10 shown adhesively attached to a surface.

FIG. 14 is a side cross sectional view of the base of the clip of FIG. 10 shown attached to a surface with a screw.

### DETAILED DESCRIPTION OF THE DRAWINGS

Alternative embodiments of the invention will be apparent to those skilled in the art from consideration of the specification and practice of the invention disclosed herein. It is intended that the specification and examples be considered as exemplary only, with a true scope and spirit of the invention being indicated by the claims which follow.

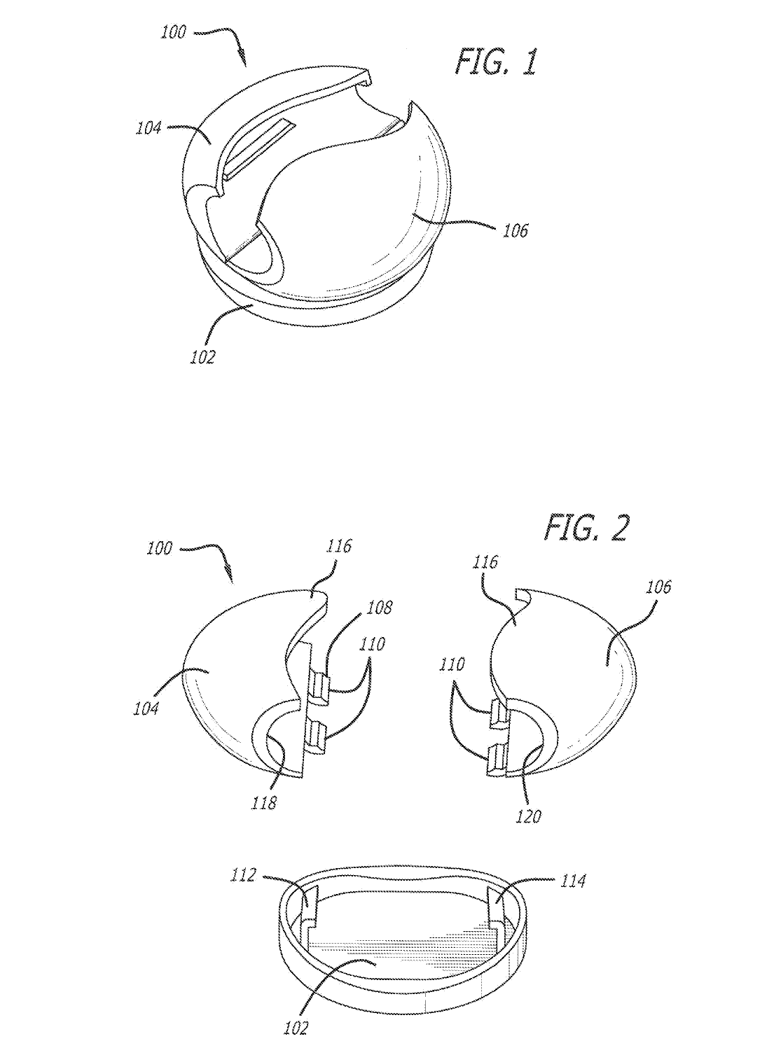

FIGS. 1 to 4 show a preferred embodiment of a clip 100 having a base 102, a first housing member 104 and a second housing member 106, where housing members 104 and 106 are preferably identical. The preferred elements of the clip 100 and their interrelationship are described below.

FIG. 2 shows an exploded view of clip 100 with interlocking hinge 108 having hinge portions 110 on housing members 104 and 106, spring mounting clips 112, 114 in base 102, interlocking wave edge 116, and housing member recesses 118, 120.

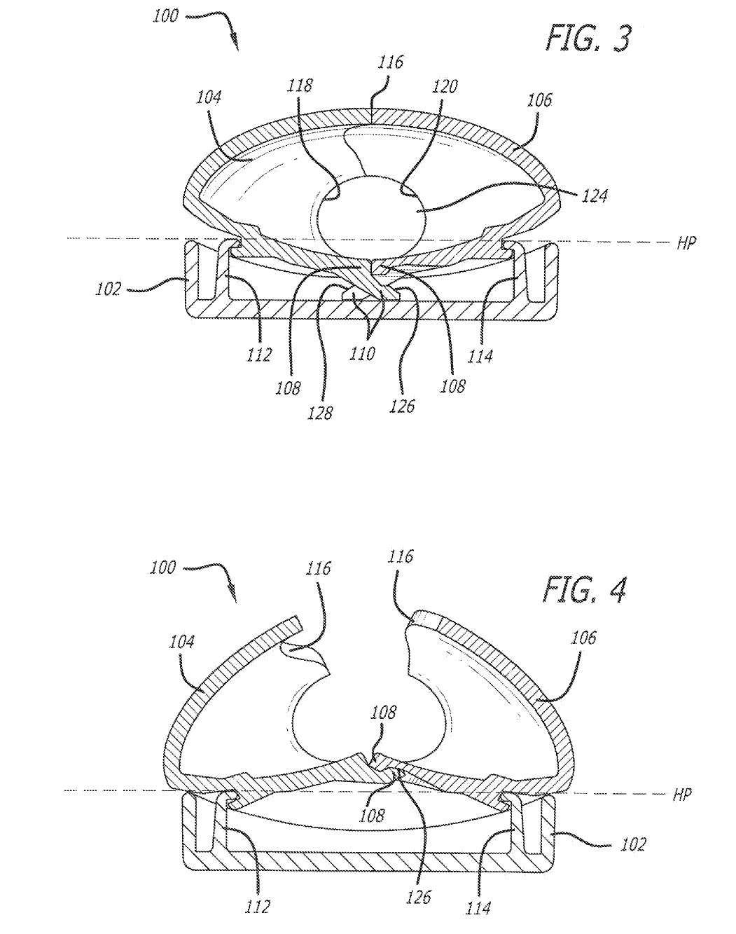

FIG. 3 shows a cross section of clip 100 in the closed position. Wave edge 116 preferably interlocks the top of housing members 104 and 106 to prevent torsional movement of the housing members and to provide an offset feature to capture movement of a cable when being removed. Wave edge 116 is formed by an upper edge of each of housing members 104, 106. Each of the upper edges forming wave edge 116 preferably includes a convex portion and a concave portion so as to be non-linear from one end of the housing member to another end of the housing member.

Referring to FIG. 3, spring mounting clips 112, 114 in base 102 exert force on housing members 104, 106 to keep hinge 108 interlocked and in a stable resting position below a horizontal plane HP. Preferably, the location of horizontal plane HP is defined by the height of spring mounting clips 112, 114. It will be appreciated that the horizontal plane may reside at other locations, for example only, a plane passing along the maximum width of the interlocked housing members, where the interlocked housing members have a length from the inlet to the outlet, and a width transverse to the length.

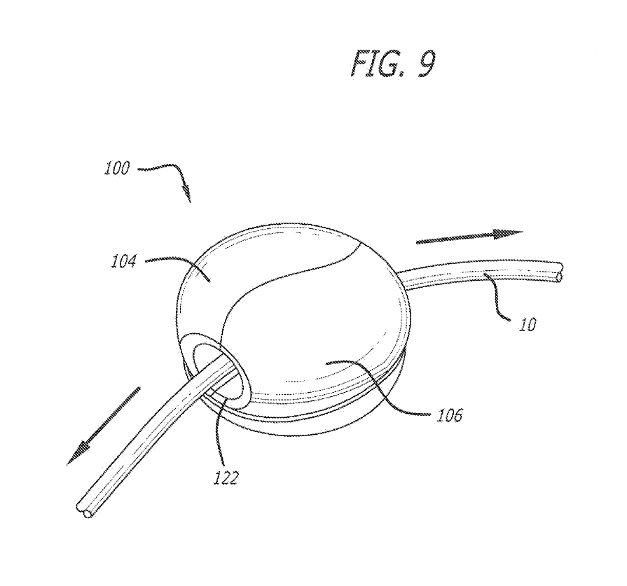

As shown in FIG. 3, hinge 108 is prevented from moving below the resting state through interference of housing members 104, 106 along wave edge 116. Housing member recesses 118, 120 provide a cavity through which a cable 10 can pass in the closed state while being captured by each housing member. In particular, recesses 118, 120 preferably form an inlet 122 and an outlet 124 in the closed position through which cable 10 may axially pass. Inlet 122 (FIG. 9) and outlet 124 are preferably axially opposite one another along a longitudinal axis. Referring still to FIG. 3, each convex portion of the upper edge of each housing member preferably forms an overhang passing through a vertical plane that is collinear with the longitudinal axis passing through inlet 122 and outlet 124. The inlet and outlet preferably have a maximum cross sectional dimension in the range of 3 to 12 mm, more preferably 5 to 10 mm. The inlet and outlet are preferably formed as an oval, but it will be appreciated that other shapes are contemplated, for example, circular and other shapes.

FIG. 4 shows a cross section of clip 100 in the open position. Wave edge 116 opens to allow access to an internal cavity. As shown in FIG. 4, the upper edges forming wave edge 116 each are curvilinear in two dimensions. Additionally, a portion of each upper edge is preferably bi-convex. Spring mounting clips 112, 114 exert force on housing members 104 and 106 to keep hinge 108 interlocked and in a stable resting position above horizontal plane HP. Hinge 108 is preferably prevented from moving above the resting state through interference of abutment members 126, 128, which preferably act to limit the travel of housing members 104, 106 in the open position, as shown in FIG. 4. Preferably, abutment members 126, 128 have a height greater than one-half the height of spring mounting clips 112, 114. When moving between the open and closed positions, abutment members 126, 128 preferably move from a position in contact with the top of base 102, through the horizontal plane, and in contact with the underside of housing members 104, 106 to limit the degree which the housing members open relative to each other.

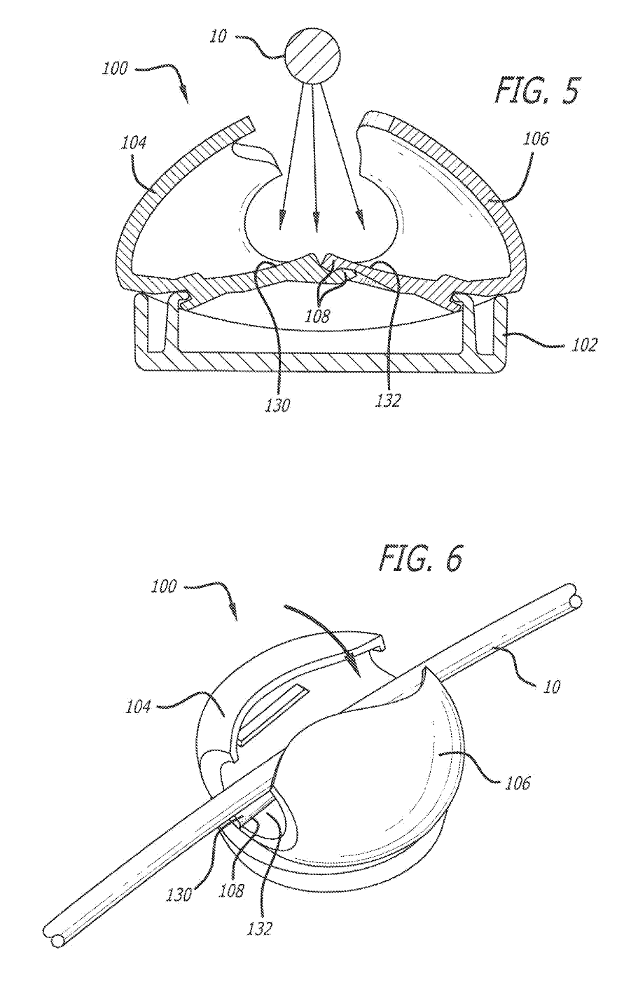

FIG. 5 shows cross section of clip 100 in the open position with cable 10 being inserted. Application of a downward force on hinge 108 or lower part of either of inner surfaces 130, 132 of housing members 104, 106 by cable 10, causes hinge 108 to move in a downwards direction, passing through the horizontal plane, into a stable resting position shown in FIG. 3.

FIG. 6 shows a perspective view of clip 100 in the open position with cable 10 being inserted. The arrow indicates direction of force. Application of downward force on hinge 108 or the lower part of either of inner surfaces 130, 132 of housing members 104, 106, respectively, by cable 10 causes hinge 108 to move in a downwards direction, through the horizontal plane, into a stable resting position shown in FIG. 3, thereby capturing cable 10 in the internal cavity.

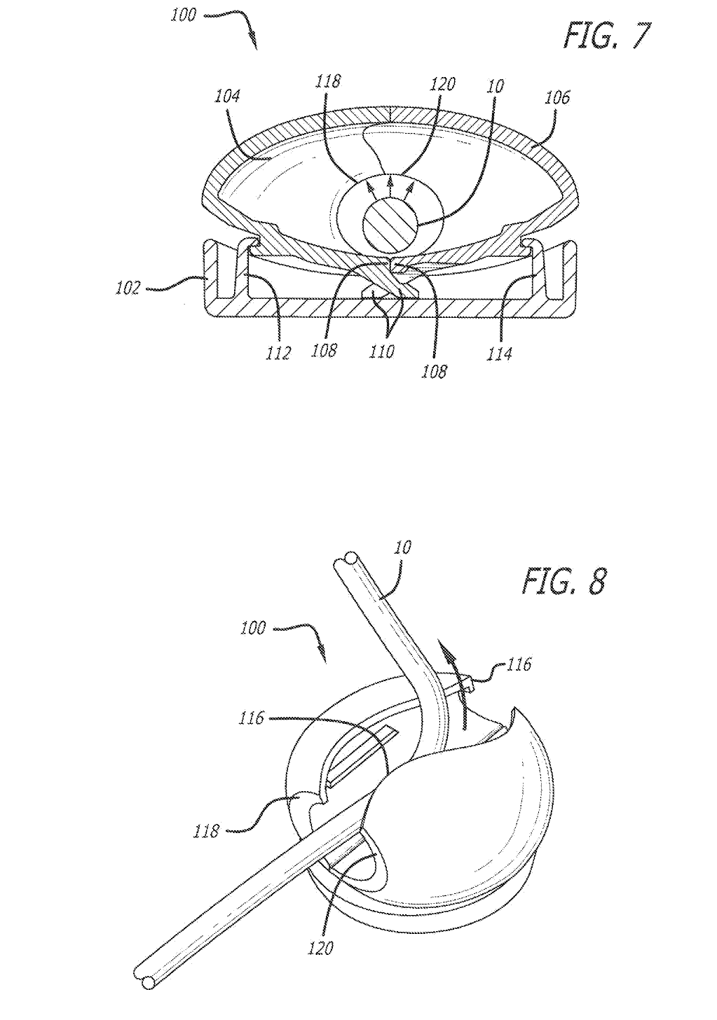

FIG. 7 shows a cross section of clip 100 in the closed position with cable 10 being removed. Application of upward force on either top part of recesses 118, 120 by cable 10, causes housing member 104 and/or 106 to pivot open on spring mounting clips 112, 114 in base 102, causing hinge 108 to move upward through the horizontal plane into a stable resting position shown in FIG. 4. Due to the interlocking nature of hinge 108, exertion of force by cable 10 on one housing member will act through a pivot on spring mounting clips 112, 114 in base 102 to leverage the opposite housing member, forcing hinge 108 to move through the horizontal plane into open stable resting state.

FIG. 8 shows a perspective view of preferred embodiment 100 in the open position as cable 10 is removed. The arrow indicates the direction of force. In situations where the top of the respective recesses 118, 120 in housing members 104, 106 do not provide sufficient structure to retain cable 10 to help leverage hinge through horizontal plane from the closed to the open position as outlined in FIG. 7, wave edge 116 provides additional interference to inhibit cable movement and derive additional leverage to move hinge 108 through horizontal plane from the closed to the open position. Wave edge 116 preferably avoids a straight line down the central opening axis in order to maximize retention of cable 10 through the overhangs to help ensure resulting force from movement of cable 10 is transferred to hinge 108.

FIG. 9 shows perspective view of clip 100 in the closed position allowing cable 10 to be freely moved through the internal cavity. In this position, insufficient force is exerted on housing member 104 or 106 to cause hinge 108 to move from the stable resting state, preferably allowing cable 10 to freely move without causing clip 100 to open.

Having described the preferred components of clip 100, a preferred method of use will now be described with reference to FIGS. 5 to 9. Referring to FIGS. 5 and 6, when clip 100 is in its open state, a user inserts cable 10 into the opening between first and second housing members 104, 106 preferably until cable 10 is between the housing members and within the perimeter of recesses 118, 120 at the inlet and outlet. The user thereafter may either continue to apply a downward force on cable 10 to move hinge 108 downwards (and close the first and second housing members), or engage the first and second housing members directly and move them toward one another. The closing of the housing members is preferably facilitated by each housing member pivoting about an axis where each housing member engages with base 102. Other ways to close first and second housing members may be used. As shown in FIG. 7, in the closed position hinge 108 is positioned closer to base 102.

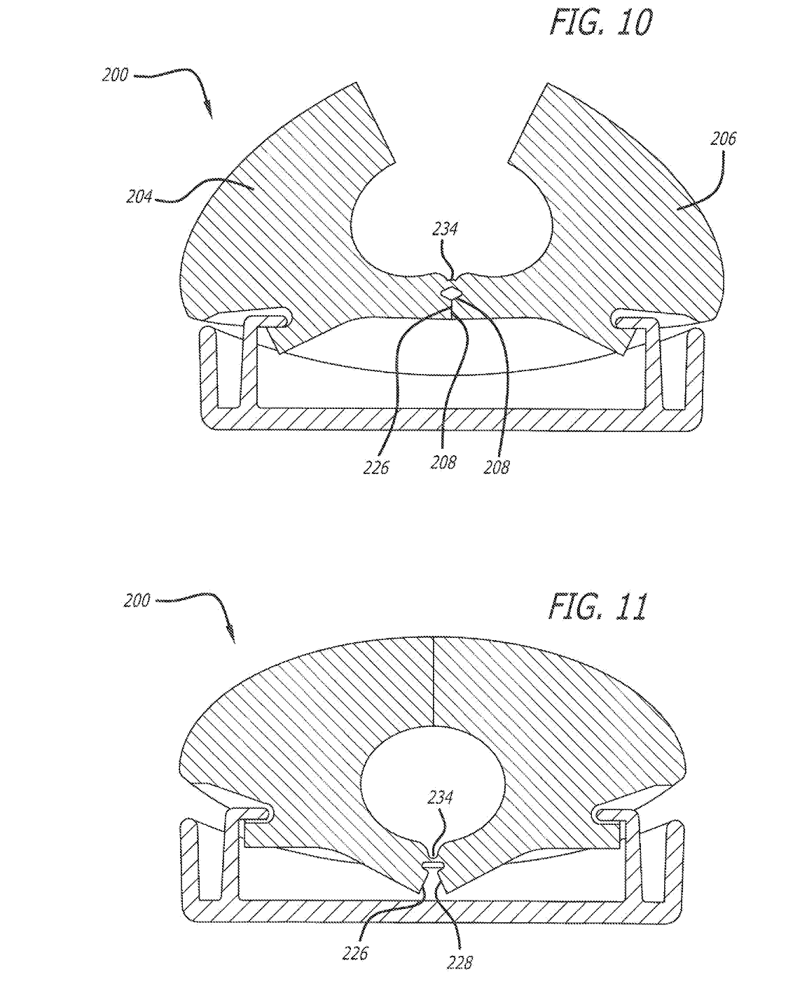

Referring now to FIGS. 10 and 11, a clip 200 is shown in accordance with another preferred embodiment of the present invention. Clip 200 is similar to clip 100 except that housing members 204, 206 are preferably connected by a living hinge 208 to form an unitary, one-piece structure or body that interconnects with base 202. Living hinge 208 is preferably formed by a thin section 234 of a thermoplastic elastomer (TPE), which has a soft, rubber-type feel and is flexible. Hinge 208 preferably includes two opposed abutment members 226, 228 below thin section 234. Abutment members 226, 228 act to limit the travel of housing members 204, 206 in the open position, as shown in FIG. 10.

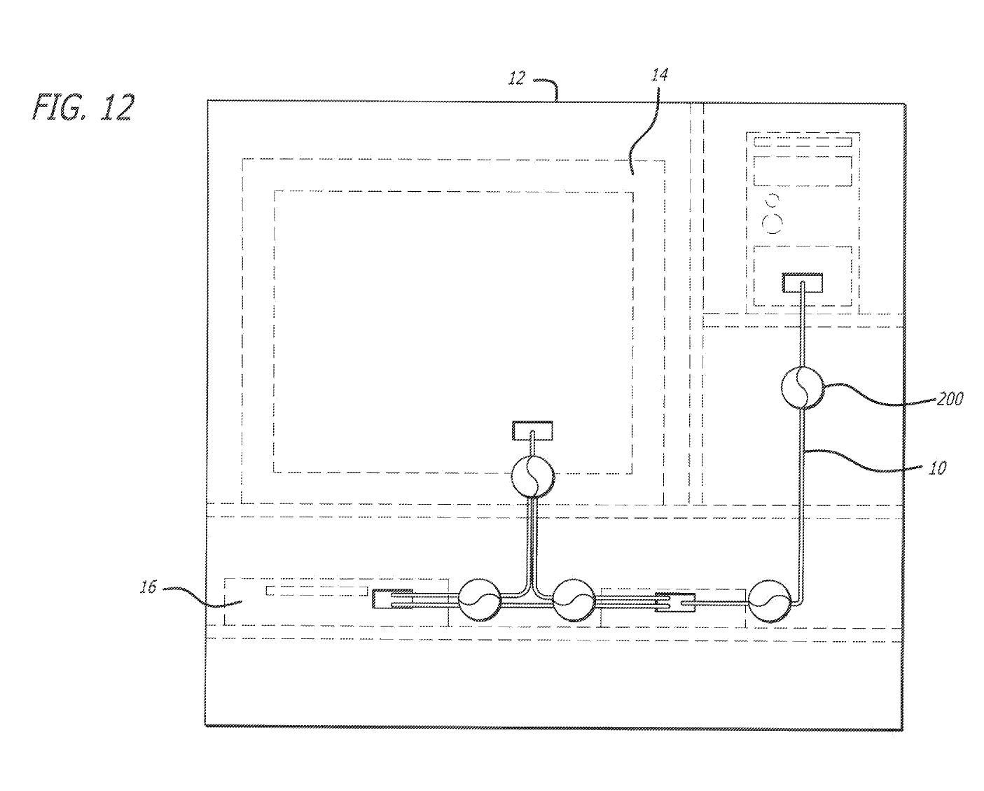

Referring to FIGS. 12 to 14, the clip may be adapted to attach to a surface, such as a wall or the rear of a computer or entertainment stand 12. FIG. 12 shows multiple clips 200 advantageously maintaining cable 10 in an organized path to several components, such as television 14 and DVD player 16. As shown in FIG. 12, for example, one of the many advantages of the clip of the present invention is that a user may easily identify cables to different components. Another advantage of the clip is that it may assist in preventing entanglements among multiple cables. It will be appreciated that the clip may be used with a plurality of cables to a wide variety of components such as computers, displays, printers, fax machines, scanners, and other electrical equipment.

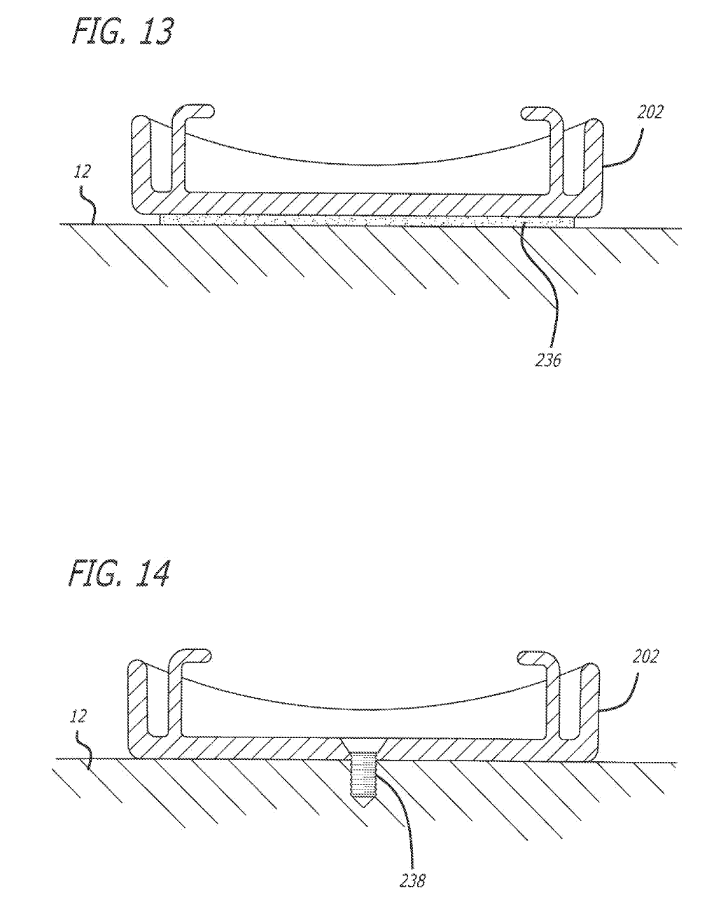

The clip may be fixedly or releasably attached to the surface of a wall or article of furniture. For example, as shown in FIG. 13, base 202 may be adhesively attached to a surface 12 with an adhesive strip 236. Strip 236 may be pre-attached to the back of base 202, and then base 202 may be attached to surface 12. Base 202 may be attached to a surface in other ways as desired. For example, base 202 may be fixedly attached to surface 12 with a screw 238 inserted therethrough as shown in FIG. 14. Other ways of attaching the base to the surface include the use of one or more magnets, clips, hooks, hook and loop fasteners and/or nails. If desired, the base need not be attachable to any surface. The clip may be adapted to suspend from one or more cables by capturing and/or grabbing the cables without being attached to any particular surface.

It will be appreciated that the clip of the present invention may be formed in a variety of ways without deviating from the general scope of the present invention. For example only, the side sections of the clip may be connected to one another in a number of ways, such as with a hinge, for example, a living hinge shown in FIGS. 10 and 11, or an interlocking hinge. The clip may be made of a variety of materials. For example only, the clip may be made from a plastic such as an ABS plastic or TPE, a metal, or a combination thereof. The clip may be transparent, translucent or opaque. If desired, an interlocking mechanism, such as a tabular snap or opposed magnets, may be included at the top of the side sections to assist in retaining the clip in the closed position. Identification may be included on the outer surface of the clip to assist a user in discerning from among multiple clips attached to multiple cables. Such identification may include the use of colors, text and/or symbols.

It will be appreciated that the clip may be formed in a variety of shapes. For example, clip 100 is shown generally dome-shaped in FIG. 1. Base 102 is preferably circular in the horizontal plane. The housing members and/or base may be formed as an oval or other shape as desired.

If desired, the interior of the clip may be uniformly smooth, or include one or more gripping structures adapted to grip a cable. For example, such gripping structures may include a plurality of rigid or flexible fins or bristles.

The features described with respect to one embodiment may be applied to other embodiments, or combined with or interchanged with the features of other embodiments, as appropriate, without departing from the scope of the present invention.

The present invention in a preferred form provides the advantages of reducing the tendency of multiple cables from becoming tangled, enhancing the organization of multiple cables and increasing the ease of identifying particular cables when there are many cables present. Advantages of using a living hinge with the clip include a reduction of the number of pieces and ease of attachment with the base.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cable holding device, comprising:
two opposed housing members sharing a central hinge moveable about a hinge axis of rotation, each of said housing members having an upper edge opposite said hinge, said housing members forming an opposed inlet and outlet adapted to surround a cable when said housing members are moved from an open position to a closed position, said upper edge of at least one of said housing members having at least one overhang, said at least one overhang in the closed position passing through a common vertical plane that is collinear with the hinge axis and passes through said inlet and outlet; and
a base with mounting members into which said housing members are interconnected.

2. The device of claim 1, wherein said upper edge of each of said housing members is curvilinear in two dimensions.

3. The device of claim 1, wherein said upper edge of each of said housing members includes a convex portion and a concave portion.

4. The device of claim 1, wherein each of said housing members includes a first end having a curved edge from said hinge to said upper edge and a second end having a curved edge from said hinge to said upper edge, said curved edges of said first ends of said housing members forming said inlet in the closed position, said curved edges of said second ends of said housing members forming said outlet in the closed position.

5. The device of claim 4, wherein said upper edge of each housing member is non-linear from said first end to said second end.

6. The device of claim 1, wherein said housing members each include at least one downwardly-depending abutment member configured to limit travel of said housing members away from one another.

7. The device of claim 6, wherein each abutment member has an end configured to travel from proximate said base to an underside of each housing member to limit the travel of said housing members relative to each other.

8. The device of claim 1, wherein said mounting members each include an upper-most surface, the upper-most surface of said mounting members forming a horizontal plane perpendicular to the vertical plane, said mounting members being positioned to bias said housing members in the closed position when said hinge is below the horizontal plane.

9. The device of claim 8, wherein said mounting members are positioned to bias said housing members in the open position when said hinge is above the horizontal plane.

10. A cable holding device, comprising:
two opposed housing members sharing a central hinge moveable about a hinge axis of rotation, each of said housing members having an upper edge opposite said hinge, said housing members forming an opposed inlet and outlet adapted to surround a cable when said housing members are moved from an open position to a closed position, said upper edge of each of said housing members having a concave portion and a convex portion; and
a base with mounting members into which said housing members are interconnected.

11. The device of claim 10, wherein said concave and convex portions of one of said upper edges are configured to come into matching engagement with said convex and concave portions of the other of said upper edges.

12. The device of claim 10, wherein said upper edge of each of said housing members is curvilinear in two dimensions.

13. The device of claim 10, wherein each of said housing members includes a first end having a curved edge from said hinge to said upper edge and a second end having a curved edge from said hinge to said upper edge, said curved edges of said first ends of said housing members forming said inlet in the closed position, said curved edges of said second ends of said housing members forming said outlet in the closed position.

14. A method of interconnecting two housing members with a base to capture a cable between the housing members, the housing members being connected to one another with a hinge, the method comprising:
engaging the two housing members with the base so that the housing members are naturally unstable in a horizontal plane located at a maximum width of the housing members, and the housing members move in relation to vertical forces from inserting or removing the cable.

15. A cable holding device, comprising:
an unitary body including a first section and a second section, said first and second sections each having an upper portion and a lower portion, said first and second sections being moveable between an open position where said upper portions move away from one another and a closed position where said upper portions move toward one another, said lower portions of said first and second sections being connected to one another by a living hinge, said lower portions of said first and second sections each including an abutment member, said abutment members being configured to abut one another to limit the amount of movement of said upper portions away from one another; and
a base adapted to receive at least a portion of said body, said base including a first mounting member configured to engage with a portion of said first section and a second mounting member configured to engage with a portion of said second section.

16. The device of claim 15, wherein said mounting members each include an upper-most surface, the upper-most surface of said mounting members forming a horizontal plane, said mounting members being positioned to bias said body in the closed position when said hinge is below the horizontal plane.

17. The device of claim 16, wherein said mounting members are positioned to bias said body in the open position when said hinge is above the horizontal plane.

18. The device of claim 15, wherein each mounting member is a spring clip.

19. The device of claim 15, wherein each of said upper portions includes an upper edge that is curvilinear in two dimensions.

20. The device of claim 15, wherein each of said upper portions includes an upper edge that has a convex portion and a concave portion.
